(19) United States
(12) Patent Application Publication
(10) Pub. No.: US 2023/0394004 A1
(43) Pub. Date: Dec. 7, 2023

(54) M.2 ADD-IN-CARD WITH UNIVERSAL FLASH STORAGE (UFS)

(71) Applicant: Intel Corporation, Santa Clara, CA (US)

(72) Inventors: Hua YANG, Beijing (CN); Zhouzhou WU, Shanghai (CN); Yean Sun YONG, Shanghai (CN); Guoqiang SU, Shanghai (CN); Shailendra Singh CHAUHAN, Bengaluru (IN); Anil Kumar NAMA, Bangalore (IN); Rajesh CHANDRAN, Bangalore (IN)

(21) Appl. No.: 18/235,172

(22) Filed: Aug. 17, 2023

(30) Foreign Application Priority Data
Jun. 5, 2023 (WO) PCT/CN2023/098215

(51) Int. Cl. G06F 13/42

(52) U.S. Cl. CPC G06F 13/4221; G06F 2213/0026

(57) ABSTRACT

M.2 Universal Flash Storage (UFS) and combined UFS/PCIe cards are described herein. In one example, the same M.2 interface is reused on the main board of laptop for supporting both PCIe SSD and UFS storage. One M.2 socket can accommodate a UFS Add-In-Card, a combined PCIe/UFS card, and/or a PCIe SSD. In one example, an M.2 UFS card includes a printed circuit board (PCB), an edge to be received by an M.2 connector, conductive contacts at the edge to couple with contacts of the M.2 connector, a UFS storage device, and UFS signal lines between the conductive contacts and the UFS storage device.

### RELATED APPLICATION

The present application claims the benefit of priority to Patent Cooperation Treaty (PCT) Application No. PCT/CN2023/098215, filed Jun. 5, 2023, the entire content of which is incorporated herein by reference.

### FIELD

Descriptions are generally related to computer storage, and more particular descriptions are related to techniques for using the same M.2 interface on a main board for supporting both PCIe SSDs and UFS storage.

### BACKGROUND

Currently, some computing systems (such as laptop products or other computing systems) are designed with support for both Peripheral Component Interconnect Express (PCIe) SSDs and UFS storage devices. Conventionally, such systems are designed with UFS chip-on-board (e.g., the UFS chip is soldered onto the main board). Systems designed with support for PCIe SSDs typically include a connector (such as an M.2 connector) on the main board to receive a PCIe SSD.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” or examples are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an example of a system with an M.2 SSD and a UFS chip-on-board.

FIG. 2 is a block diagram of an example of a system with an M.2 connector for coupling an SSD or UFS storage device with the system.

FIG. 3 illustrates an example of an M.2 UFS add in card relative to M.2 PCIe SSDs.

FIG. 4 is a block diagram of an example of UFS and PCIe signals between an SoC and an M.2 UFS card.

FIG. 5 is a block diagram of an example of PCB chains on a main board and an M.2 UFS card.

FIGS. 6A-6C illustrate examples of pinouts of an M.2 Key M Socket that can support an M.2 UFS card.

FIGS. 7A and 7B illustrate a common SoC package with different pin definitions to support UFS storage or PCIe storage.

FIG. 7C illustrates an SoC package with configurable port support.

FIG. 8 is a block diagram of an example of an M.2 UFS add in card.

FIG. 9 illustrates an example of a firmware configuration to support both UFS and PCIe SSD Storage.

FIG. 10 is a block diagram of an embodiment of a computing system in which an M.2 UFS add-in-card can be included.

Descriptions of certain details and implementations follow, including a description of the figures, which may depict some or all of the embodiments described below, as well as discussing other potential embodiments or implementations of the inventive concepts presented herein.

### DETAILED DESCRIPTION

M.2 Universal Flash Storage (UFS) and combined UFS/PCIe cards are described herein.

Existing computing systems, such as mobile computing systems, may include support for both UFS and PCIe storage options even though a given product (e.g., a given product Stock Keeping Unit (SKU)) may not utilize both the UFS and PCIe options. For example, some products targeting different markets may include only UFS storage, only PCIe storage, or both PCIe and UFS storage. The M.2 interface is commonly the standard interface used for the connection of PCIe SSD storage. The M.2 standard is described in the PCI Express M.2 Specification, such as the PCIE Express M.2 Specification Rev. 5.x, originally released by PCI-SIG on May 12, 2023, PCI Express M.2 Specification Rev. 4.x, originally released Nov. 17, 2020, or earlier versions such as PCI Express M.2 Specification Rev 1.x, 2.x, or 3.x, or future M.2 versions in development. Existing UFS storage devices are mounted on the board (e.g., soldered to the main board).

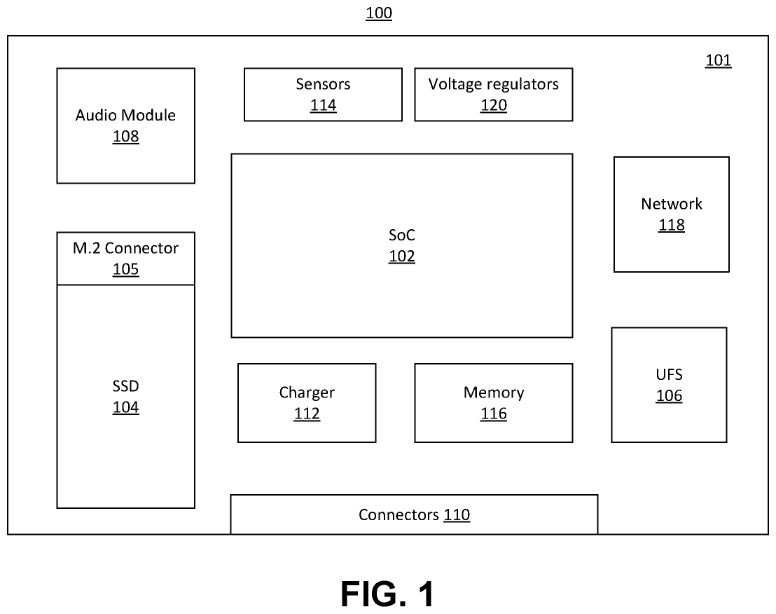

FIG. 1 is a block diagram of an example of a system with an M.2 SSD and a UFS chip-on-board. The system 100 includes a printed circuit board (PCB) 101 (e.g., a main board or motherboard). In the example in FIG. 1, the system 100 includes an SoC 102, memory 116, voltage regulators 120, a network interface 118, a charger 112, sensors 114, an audio module 108, and connectors 110. Other systems may include additional or different components than the system 100. In one example, the system 100 is a laptop or other mobile system with support on the PCB 101 for both a UFS chip 106 on-board and an M.2 PCIe SSD 104 via an M.2 connector 105.

Therefore, regardless of whether a UFS storage device is used for a particular computing device, the main board of such devices includes support for the UFS chip. Accordingly, this approach can result in consuming more PCB board space than necessary for some products, which is not beneficial for smaller system designs (e.g., in terms of the x-y dimension of the product). For example, a UFS chip-on-board can occupy several percent (e.g., ˜3% or more) of the total PCB area.

Furthermore, the UFS chip-on-board design can lead to additional maintenance costs for different PCB assembly configurations. UFS chip-on-board designs can also lead to problems during testing and debugging. During the debug process of a UFS chip-on-board, if there is a requirement to swap the UFS chip for debugging purposes, it will result in manual rework. For example, a UFS chip may need to be removed and another UFS chip re-soldered to the board, which is time consuming and can damage or destroy the component. Additionally, if a UFS chip is swapped out with an alternate UFS chip due to suspected compatibility issues, the alternate UFS chip needs to have the same footprint as the removed UFS chip, which limits the choice of alternate UFS chips for debugging.

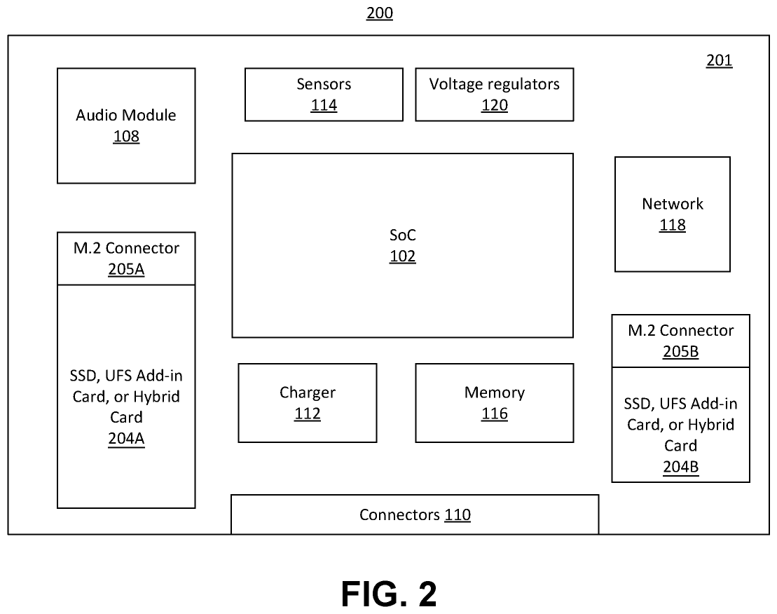

In contrast, the same M.2 connector can be used for both PCIe SSD and UFS storage devices. In one example, a system can include a single M.2 connector or multiple M.2 connectors to support one or more UFS storage devices, PCIe SSDs, or combined PCIe/UFS cards. FIG. 2 is a block diagram of an example of a system 200 with an M.2 connector for coupling a PCIe SSD, UFS storage card, or combined PCIe/UFS card with the system 200. Although FIG. 2 illustrates a PCB 201 with two M.2 connectors 205A, 205B, other examples can include a single M.2 connector (e.g., either the M.2 connector 205A or the M.2 connector 205B configured to support a UFS, UFS/PCIe, or PCIe storage module), or more than two M.2 connectors (at least one of which can support a UFS, PCIe/UFS or PCIe storage modules).

Unlike conventional systems with UFS on-board, the system 200 includes a PCB 201 with one or more M.2 connectors 205A, 205B that can receive a PCIe SSD, an M.2 UFS card 204A, 204B, or combined UFS/PCIe card. Thus, in one example, the same M.2 interface is reused on the main board of a laptop or other system for supporting both PCIe SSD and UFS storage, so that there is not wasted PCB space for products that do not include UFS storage devices. Furthermore, for products that do include UFS storage devices, testing and debugging is made less expensive and less time consuming due to the ease of removing and replacing UFS devices that are coupled with the system 200 via an M.2 connector.

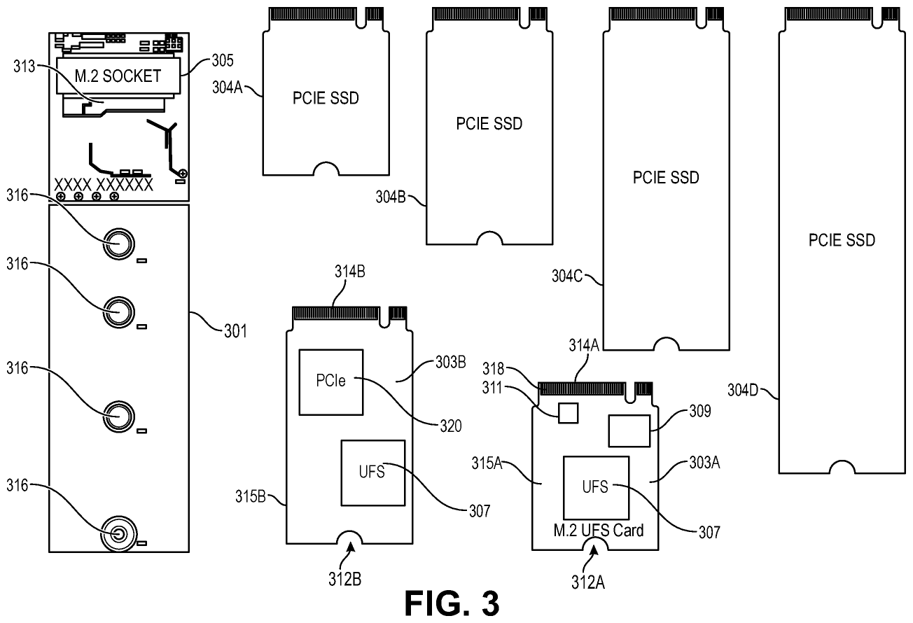

Accordingly, one M.2 socket can accommodate an M.2 UFS card, a PCIe SSD, or combined (hybrid) PCIe/UFS card. In the example in FIG. 2, the PCB 201 is shown as including two different sized footprints for the SSDs or M.2 UFS cards 204A, 204B attached with the M.2 connectors 205A, 205B. FIG. 3 illustrates different sized PCIe SSDs and examples of an M.2 UFS card and a combined M.2 UFS/PCIe card relative to M.2 PCIe SSDs.

Referring to FIG. 3, a section of a main board 301 is shown for accommodating PCIe SSDs, M.2 UFS add in cards, or combined M.2 UFS/PCIe cards. The main board 301 can be the same as, or similar to, the PCB 201 of FIG. 2. The main board includes an M.2 connector 313, which includes a slot or socket 305 for receiving M.2 compatible PCIe devices, UFS cards, or combined UFS/PCIe cards. The main board 301 includes holes 316 at several locations to receive fasteners (e.g., screws or other fasteners) to secure PCIe SSDs or M.2 UFS cards or UFS/PCIe to the main board 301.

Several sizes of PCIe SSDs are illustrated in FIG. 3. The PCIe SSD 304A is an example of a 2230 PCIe SSD, which is 22×30 mm. The PCIe SSD 304B is a 2242 SSD, which is 22×42 mm. The PCIe SSD 304C is an example of a 2260 PCIe SSD, which is 22×60 mm, and the PCIe SSD 304D is an example of a 2280 SSD, which is 22×80 mm. Each of the PCIe SSDs 304A-304D are compatible with the M.2 standard and can be received by the M.2 connector 313. Other or future versions of the PCIe and M.2 standards may define or support different or additional sizes than those depicted in FIG. 3.

An example of an M.2 UFS card 303A is also shown in FIG. 3. Note that although the term “card” is used throughout this disclosure, an M.2 compatible card with UFS and/or PCIe storage devices can also be referred to as an add-in card, a module, a storage module, an SSD, or a daughter board. The M.2 UFS card 303A is shown as having the dimensions of the PCIe SSD 304A, however, other examples of M.2 UFS cards can have different dimensions, such as the dimensions of the PCIe SSDs 304B-304D, dimensions in accordance with other or future PCIe standards, or other dimensions that are different than the PCIe standard dimensions. The M.2 UFS card 303A includes one or more UFS storage devices 307 (which can also be referred to as UFS chips or UFS storage chips). In one example, the UFS storage device 307 is mounted on the card 303A (e.g., mounted on the PCB 315A of the card 303A) instead of on the mainboard of the system.

The UFS storage device 307 includes a storage array for storing data and is compatible with a current or future UFS standard, such as UFS version 2.x (e.g., 2.0, 2.1, and 2.2), UFS version 3.x (e.g., 3.0 and 3.1), and version 4.1 (e.g., 4.0, etc.). Examples of UFS standards include: UFS 2.1 (JESD220C-2.1, originally published by JEDEC (Joint Electronic Device Engineering Council) March 2016), UFS 2.2 (JESD220C-2.2, originally published by JEDEC August 2020), UFS 3.0 (JESD220D, originally published by JEDEC January 2018), and UFS 4.0 (JESD220F, originally published by JEDEC August 2022). The UFS family of standards also includes a UFS Host Controller Interface standard (e.g., UFSHCI 4.0 (JESD223E, published August 2022).

Referring again to FIG. 3, the M.2 UFS card 303A includes an edge 314A to be received by an M.2 connector 313. The M.2 UFS card 303A includes a plurality of conductive contacts 318 (e.g., pins) to couple with corresponding contacts of the M.2 connector 313. The PCB 315A also includes a hole 312A (e.g., a cutout or opening) to receive a fastener to secure the M.2 UFS card 303A to the main board 301.

In addition to the UFS storage device 307, the M.2 UFS card 303A includes a clock buffer 311. The clock buffer 311 is to receive a UFS clock signal via one of the pins of the M.2 connector 313 and drive the UFS clock signal to the UFS storage device 307. The M.2 UFS card 303A also includes one or more voltage regulators 309 to receive a voltage via the M.2 connector 313 and provide one or more reference voltages to the UFS storage device 307.

FIG. 3 also illustrates an example of a hybrid or combined M.2 UFS/PCIe card 303B. The combined M.2 UFS card 303B is shown as having the dimensions of the PCIe SSD 304B, however, other examples of combined M.2 UFS/PCIe cards can have different dimensions, such as the dimensions of the PCIe SSDs 304B-304D, dimensions in accordance with other or future PCIe standards, or other dimensions that are different than the PCIe standard dimensions. The M.2 UFS card 303B includes one or more UFS storage devices 307 and one or more PCIe devices 320. Like the M.2 UFS card, the combined M.2 UFS/PCIe card 303B includes the UFS storage device 307 mounted on the card 303B (e.g., mounted on the PCB 315B of the card 303B) instead of on the mainboard of the system. In addition to the UFS storage, the PCIe device 320 is also mounted on the card 303B. As is explained in more detail below, the M.2 connector can support a lower PCIe link width (e.g., ×2 lanes) together with UFS in one pinout.

Like the M.2 UFS card 303A, the combined M.2 UFS/PCIe card 303B includes an edge 314B to be received by an M.2 connector 313. The M.2 UFS card 303B includes a plurality of conductive contacts to couple with corresponding contacts of the M.2 connector 313. The PCB 315B also includes a hole 312B (e.g., a cutout or opening) to receive a fastener to secure the M.2 card 303B to the main board 301.

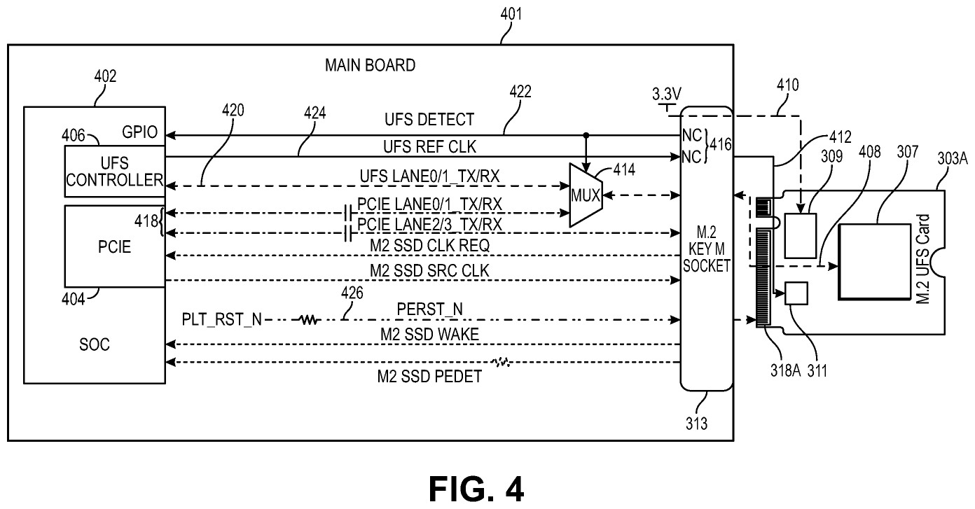

Various techniques can be used to enable M.2 support for UFS, PCIe, or combined PCIe/UFS modules. For example, FIG. 4 illustrates an example in which the main board 401 includes multiplexer circuitry to multiplex UFS and PCIe signals to a common M.2 connector.

FIG. 4 is a block diagram showing UFS and PCIe signals between an SoC 402 and an M.2 UFS card 303A. In one example, in the main board 401, both PCIe and UFS data lanes would reuse the same M.2 PCIe data pins. In one such example, there is a multiplexer 414 (e.g., a high-speed switch or other multiplexer circuitry) on the main board 401 which would switch between PCIe data lanes and UFS data lanes. For example, FIG. 4 illustrates an SoC 402 with both UFS controller logic 406 and PCIe controller logic 404. The UFS controller 406 includes host-side control logic for controlling and communicating with the UFS storage device 307. The PCIe controller logic 404 includes host-side control logic for controlling and communicating with a PCIe storage device that may be coupled with the system via the M.2 connector 313. In one example, the PCIe controller is or includes a Non-Volatile Memory Express (NVMe) interface. In one such example, the logic 404 includes NVMe interface logic for interfacing with storage devices coupled with the SoC 402 via the M.2 connector 313. The logic 404 can be in accordance with an NVMe standards, such as NVMe 2.0, (originally released May 2021), NVMe 1.4 (originally released June 2019), NVMe 1.3 (originally released 2017), or an earlier or future version of the NVMe standard. The main board 401 includes signal lines in or on the PCB to couple the UFS controller 406 and the PCIe controller logic 404 with the M.2 connector 313.

For example, the main board includes UFS signal lines coupled with the M.2 connector 313, such as the UFS Detect signal line 422, the UFS reference clock 424 (e.g., UFS REF CLK), UFS data lanes 420 (e.g., UFS Lane 0/1_TX/RX). The main board 401 also includes PCIe signal lines coupled with the same M.2 connector 313, such as PCIe data lanes 418 (e.g., PCIE Lane0/1_TX/RX, PCIe Lane 2/3_TX/RX), a reset signal 426 (e.g., PERST_N), and other PCIe signal lines (e.g., SSD CLK REQ, SSD SRC CLK, SSD WAKE, and SSD PEDET).

In the illustrated example, multiplexer circuitry (e.g., the multiplexer 414) is to select one or more of the PCIe data lanes 418 or the UFS data lanes 420 based on a select input. In the illustrated example, the multiplexer is to select the PCIe data lanes or the UFS data lanes based on the UFS detect signal 422. In this way, both UFS and PCIe signal lines can be coupled with the same M.2 connector and, depending on whether the system is configured for a PCIe SSD or an M.2 UFS card, the multiplexer 414 will select the appropriate data lanes and provide the selected data lanes to the data pins of the M.2 connector 313. When the UFS data lanes are selected, the UFS data on those signal lines is transmitted via the data pins of the M.2 connector 313 and via data signal lines 408 on the M.2 UFS card 303A.

In an example in which a combined M.2 PCIe/UFS card is supported, some of the PCIe lanes are coupled directly with the M.2 connector, and other PCIe lanes are coupled with the M.2 connector via multiplexer circuitry. For example, the PCIe data lanes coupled with the M.2 connector include multiple data lanes (e.g., lanes 0, 1, 3, and 3 for a ×4), wherein a subset of the multiple data lanes are inputs to the multiplexer circuitry, and the other PCIe data lanes bypass the multiplexer circuitry. In one such example, the contacts of the M.2 connector coupled with the UFS storage device include M.2 PCIe pins for a subset of the PCIe lanes (e.g., lanes 2 and 3), and the contacts of the M.2 connector coupled with the PCIe storage device include second M.2 PCIe pins for one or more other PCIe lanes (e.g., lanes 0 and 1). In one such example, the M.2 connector can support a ×4 PCIe SSD, a UFS card, or a combined PCIe/UFS card with ×2 PCIe support. In other examples, different lanes can be used for multiplexing in the combined M.2 PCIe/UFS case (e.g., lanes 0 and 1, lanes 0 and 2, etc.). Although the specific examples here refer to a ×2 PCIe and UFS combined M.2 card, in other examples, different PCIe data link widths may be supported.

In one example, the UFS Detect signal line 422 is received by the SoC 402 to enable the SoC to dynamically detect whether an M.2 UFS card, a PCIe SSD, or a combined UFS/PCIe device (or other card) is plugged into the M.2 connector 313. Note that although FIG. 4 depicts a single UFS Detect signal line communicated via a single pin, in different implementations, a single signal line or multiple signal lines may be used to indicate the type of card or module plugged into the M.2 connector. For example, if the UFS Detect signal indicates one of two M.2 card types (e.g., either an M.2 UFS card or a PCIe SSD), a single Detect signal can be used.

If the UFS Detect signal is to indicate more than two M.2 card types (e.g., an M.2 UFS card, a PCIe SSD, or a combined M.2 PCIe/UFS card), a multi-bit signal or signals can be used to indicate the M.2 card type. Thus, in one example, the logic value (e.g., logic ‘0’ or logic ‘1’ in the case of a single bit detect signal, or other logic values for a multiple-bit detect signal) driven on the UFS Detect signal line(s) 422 indicates the type of card or module plugged into the M.2 connector (e.g., an M.2 UFS card, a PCIe SSD, or a combined UFS/PCIe device). Note that although the signal line 422 is referred to as “UFS Detect” in this disclosure, the labels are examples and not limiting; for example, the signal line 422 could be referred to as “PCIe Detect,” “M.2 card detect,” or another label. Thus, one or more signals from the M.2 module indicate the type of device plugged into the M.2 connector to enable dynamic detection of the M.2 card type.

In one example, one or more of the UFS signal lines are coupled with pins 416 of the M.2 connector which are considered reserved or “not connected” for PCIe devices. In one such example, the UFS detect signal 422 and the UFS reference clock signal 424 are coupled with reserved pins of the M.2 connector 313. In the illustrated example, the reference clock signal (UFS REF CLK) is provided to a clock buffer 311 via one of the pins of the M.2 connector 313 and a clock signal line 412, and then the clock buffer 311 drives the clock signal to the UFS storage device 307. In one example, the same reset signal line and pin are used for both a PCIe SSD and an M.2 UFS card. For example, in FIG. 4, the PERST_N signal line 426 is coupled with the reset pin of the M.2 connector 313 and used for both PCIe SSDs and M.2 UFS cards coupled with the M.2 connector 313. Thus, in one example, the M.2 PCIe data pins are used for both PCIe TX/RX and UFS TX/RX data lines. The M.2 PCIe reset pin is used for both PCIe and UFS reset signal. One reserved (not connected or “NC”) pin is used for UFS AIC attached detection (UFS DETECT), and one M.2 NC pin is used for UFS reference clock connection (UFS REF CLK). In one example, more than one NC pin is used for Detect signals.

In the example illustrated in FIG. 4, a supply voltage (in this example, 3.3 V) is provided to the M.2 UFS card 303 via the M.2 connector 313 and power line(s) 410 on the M.2 UFS card 303. In one example, the higher supply voltage from the M.2 connector 313 is provided to one or more voltage regulators 309 of the M.2 UFS card 303. One or more lower voltages can then be provided by the voltage regulators 309 to the UFS storage device 307.

Although the example in FIG. 4 depicts an M.2 UFS card 303A, a main board with multiplexer circuitry such as the example depicted in FIG. 4 could support a combined PCIe/UFS card, such as the card 303B of FIG. 3. In one such example, only some of the PCIe data lanes are multiplexed with the UFS data signals, and the other PCIe data lanes are routed to the M.2 connector. For example, rather than either UFS signals or PCIe signals, a subset of PCIe lanes in addition to UFS signals can be routed to the M.2 connector for supporting a combined M.2 PCIe/UFS card.

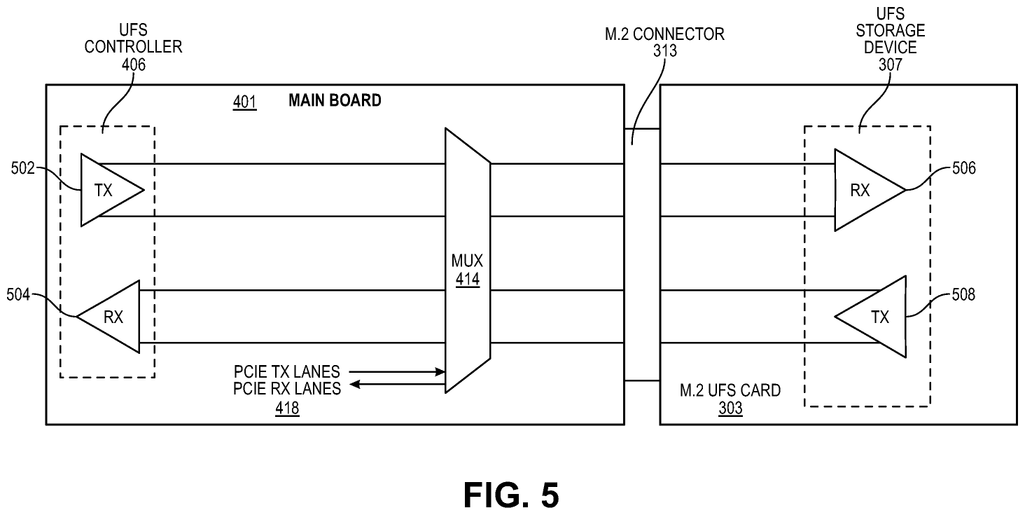

FIG. 5 is a block diagram of an example of PCB chains on a main board and an M.2 UFS card. As can be seen in the example of FIG. 5, there is transmitter and receiver circuitry on both the host side (the UFS controller 406) and the device side (the UFS storage device 307). Specifically, the UFS controller 406 includes transmitter circuitry 502 to transmit signals to the M.2 UFS card 303 via the M.2 connector 313, and receiver circuitry 504 to receive signals from the M.2 UFS card 303 via the M.2 connector 313. Similarly, the UFS storage device 307 on the M.2 UFS card 303 includes receiver circuitry 506 to receive the transmitted signals from the UFS controller 406 and transmitter circuitry 508 to transmit signals to the UFS controller 406. In one example, the high-speed link design requirements for both PCIE data link and UFS data link on the motherboard should follow the stricter of the two routing requirements from the platform design guide. In one such example, the length of UFS TX/RX link on M.2 UFS card is better to keep as short as possible.

Thus, the example in FIG. 5 illustrates one example of a main board and M.2 UFS card configuration that can support both PCIe SSD storage and UFS storage with the same M.2 connector. The main board 401 enables both PCIe and UFS data lanes to reuse the same M.2 PCIE data pins. The multiplexer 414 on the main board 401 switches between PCIe data lanes and UFS data lanes.

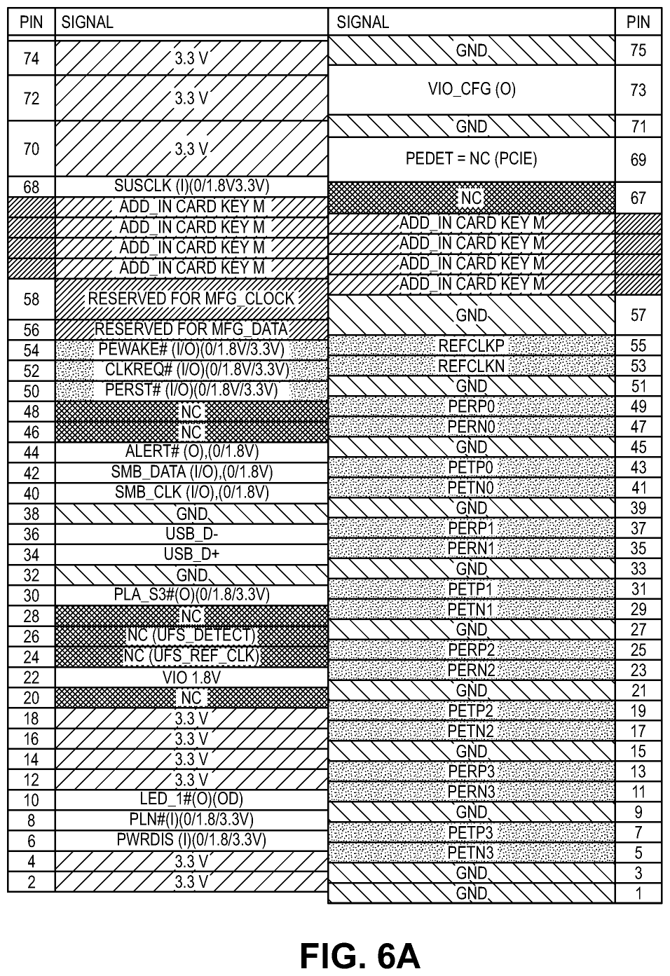

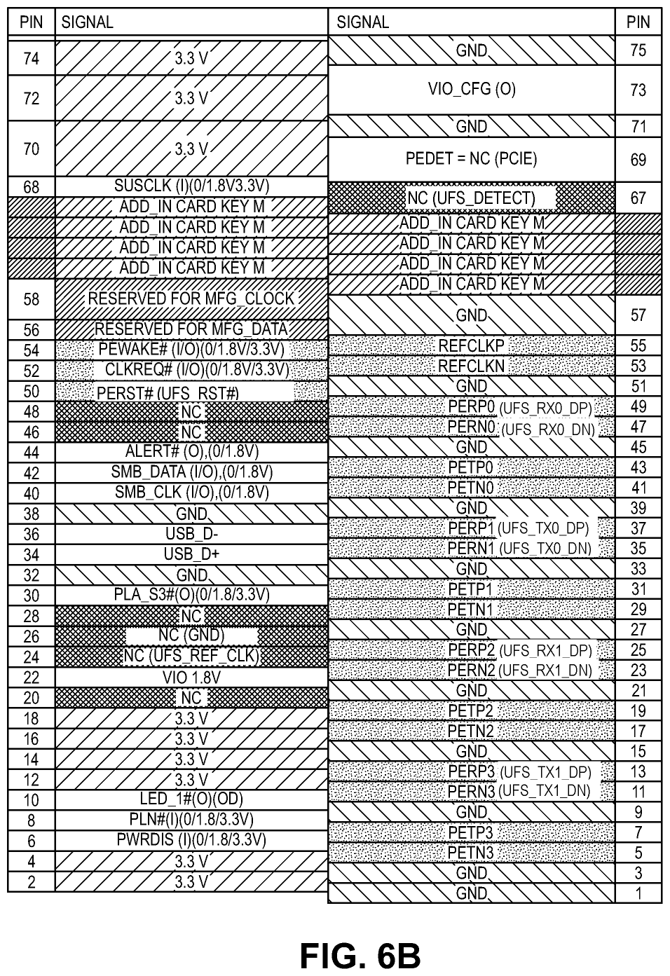

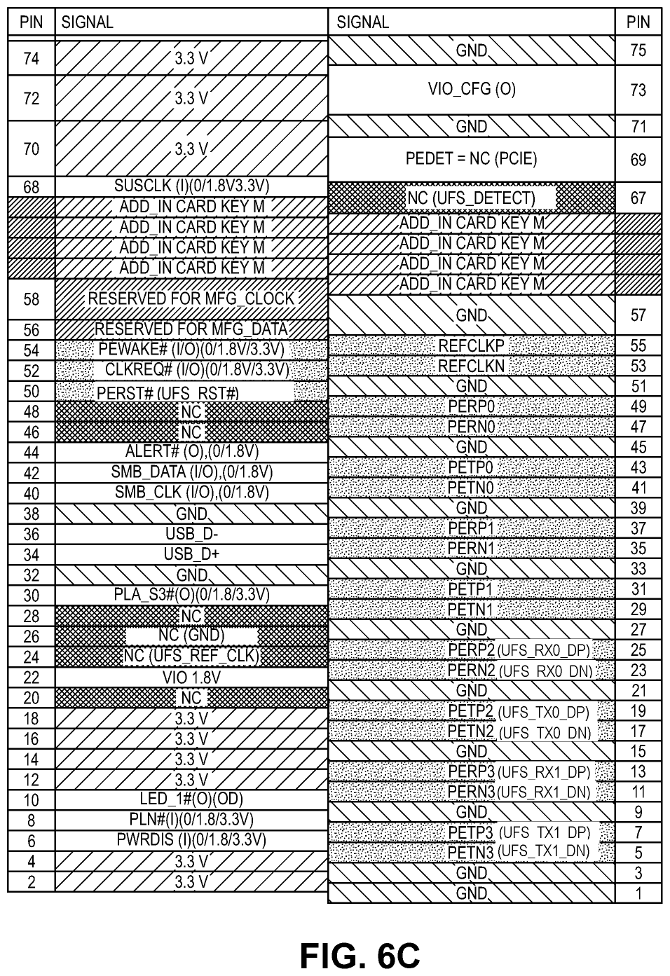

FIGS. 6A-6C illustrate examples of pinouts of an M.2 Key M socket that can support an M.2 UFS card. Turning first to the example in FIG. 6A, there are no changes on the original M.2 Key M signal definition except two redefined M.2 NC (reserved) pins. One NC pin in M.2 key M socket is redefined as UFS DETECT (e.g., pin 26) and another NC pin is redefined as UFS REF CLK (e.g., pin 24) for supporting M.2 UFS Add-In-Card functionality. However, other examples may provide the UFS detect and UFS reference clock signals via other pins of the M.2 socket. In one example, the M.2 pins for data signals (TX and RX signals) can be used for UFS or PCIe data signals. For example, the pinout of FIG. 6A shows pins 5, 7, 11, 13, 17, 19, 23, 25, 29, 31, 35, 37, 41, 43, 47, and 49 as used for TX and RX data signals. In one example, pins for some of the PCIe lanes, such as lanes 0 and 1 or lanes 2 and 3, are used for UFS data signals when a UFS M.2 card is plugged into the M.2 connector.

FIG. 6B illustrates another example of an M.2 pinout. Like the example in FIG. 6A, some of the NC pins of the M.2 connector are used for the UFS_REF_CLK (e.g., pin 24) and UFS_DETECT (e.g., pin 67) signals. In the example illustrated in FIG. 6B, only the PCIe RX pins are used for the UFS data signals (e.g., pins 11, 13, 23, 25, 35, 37, 47, and 49). In one such example, the issue of capacitors on the TX path of the motherboard for PCIe can be addressed without multiplexer circuitry on the motherboard by using only PCIe RX pins for the UFS data signals. FIG. 6C illustrates another example of a pinout that is similar to the pinout in FIG. 6B, except both the PCIe TX and RX pins for lanes 2 and 3 are used for the UFS signals. Thus, in one example, the pinout of FIG. 6C is used for a motherboard with multiplexer circuitry to multiplex the UFS and PCIe data signals for lanes 2 and 3. In one example, the pinout of FIG. 6C may be used for a combined M.2 PCIe/UFS card. For example, the pinout of FIG. 6C can support PCIe lanes 0 and 1 simultaneously with UFS.

Thus, FIGS. 6A-6C illustrate examples of M.2 connector pinouts to support PCIe, UFS, and combined PCIe/UFS cards. Note that the examples in FIGS. 6A-6C illustrate M.2 Key M configurations, however, other M.2 pinout configurations may similarly support M.2 UFS cards, PCIe SSDs, and/or combined PCIe/UFS cards.

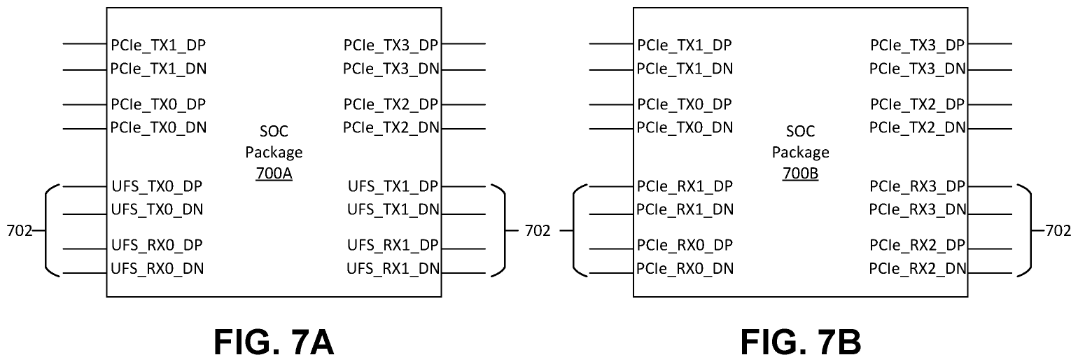

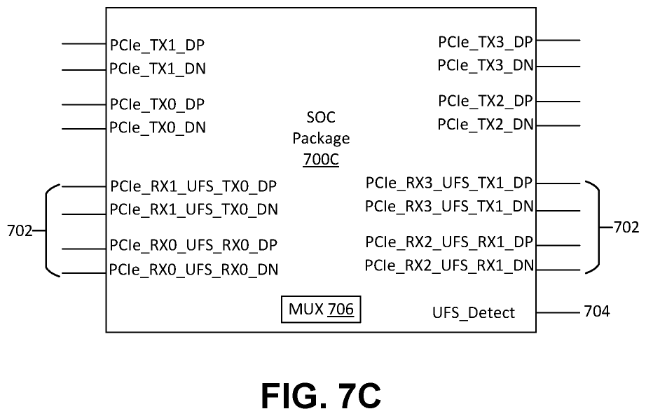

Some of the examples above refer to systems in which the motherboard includes multiplexer circuitry that selects either UFS or PCIe lanes based on a signal (e.g., UFS Detect). In one such example, the SoC includes dedicated pins and physical layers (PHYs) for both UFS and PCIe. FIGS. 7A-7C illustrate additional examples of how both UFS and PCIe can be supported with UFS and PCIe pin multiplexing.

FIGS. 7A and 7B illustrate a common SoC package with different pin definitions to support UFS storage or PCIe storage. In the example in FIGS. 7A and 7B, the SoCs 700A, 700B include either a dedicated UFS PHY or a dedicated PCIe PHY, and the same pins on the common SoC package are used for either UFS or PCIe signals depending on the whether the SoC supports UFS or PCIe. For example, referring to FIGS. 7A, the pins 702 are used for UFS data signals. In FIG. 7B, the same pins 702 are used for PCIe data signals. Thus, a common SoC package 700A, 700B can be used to support both SoCs with UFS storage and SoCs with PCIe storage. In one such example, neither the SoC nor the motherboard include multiplexer circuitry. For example, referring to FIG. 2, if the SoC 102 has the common SoC package design of FIGS. 700A, 700B, neither the SoC 102 nor the PCB 201 may have multiplexer circuitry. Instead of multiplexer circuitry, the common SoC package has pins that are either routed to UFS circuitry or PCIe circuitry. For example, referring again to FIGS. 7A and 7B, in one such example, the UFS or PCIe signals are routed between the pins 702 of the SoC package 700A or 700B and the M.2 connector (e.g., the M.2 connectors 205A, 205B of FIG. 2), and between the pins 702 and storage control logic of the SoC 700A, 700B.

FIG. 7C illustrates an SoC package with configurable port support. In one such example, the SoC includes a combo PHY (physical layer) to support both PCIe and UFS. In one such example, multiplexer circuitry 706 is integrated into the SoC 700C. A signal (e.g., UFS_DETECT as shown in FIG. 7C) can be used to dynamically detect whether a storage module coupled with an M.2 connector is a UFS (e.g., M.2 UFS card) or PCIe storage module. The multiplexer circuitry can then route the signals between the pins 702 and UFS or PCIe control circuitry based on the whether UFS or PCIe storage is detected.

In one example in which multiplexer circuitry on the motherboard is not used for UFS/PCIe pin multiplexing, the UFS and PCIe topologies are considered in determining which pins of the M.2 connector to use for multiplexing the UFS and PCIe signals. In one example, the UFS protocol does not require an AC coupling capacitor on the TX or RX paths, but the PCIe protocol requires an AC coupling capacitor on the path for TX on the motherboard. Thus, in one such example, PCIe_RX signal lines are used for multiplexing with the UFS signal lines to enable seamlessly using the PCIe or UFS solutions on a common platform. In an example in which the motherboard includes multiplexer circuitry to enable multiplex UFS and PCIe signal lines between the SoC and the M.2 connector, PCIe_RX and/or PCIe_TX signal lines can be used for multiplexing with the UFS signal lines. Thus, in one example, multiplexer circuitry on the SoC also enables supporting a combined M.2 PCIe/UFS card (e.g., by enabling the use of the RX and TX signal lines of one or more PCIe lanes for multiplexing with the UFS signal lines).

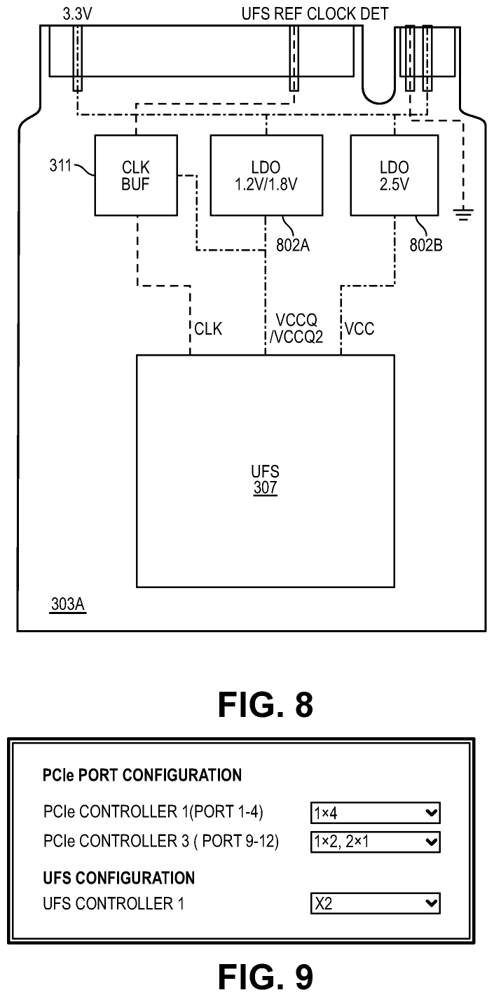

FIG. 8 is a block diagram of an example of an M.2 UFS add in card 303A. In the example in FIG. 8, the M.2 UFS card includes a UFS chip (UFS storage device 307), UFS power supply chips (e.g., voltage regulators 802A, 802B), and a UFS clock buffer 311. The UFS standard has historically included some variations in the power delivery specifications between versions. In one example, to address the changes in power delivery specifications, the M.2 UFS card includes one or more voltage regulators, such as low drop-out regulators (LDOs) to provide multiple voltages in accordance with multiple versions of the UFS standard. For example, for UFS version 3.1/version 4.0, two LDOs (Low Drop-Out Regulators) are included as VCC (2.5V) and VCCQ (1.2V), respectively. However, for versions 2.x, the M.2 3.3V supply voltage can be used directly as UFS VCC, and therefore only one LDO may be included on the M.2 UFS card 303 for VCCQ at 1.8V.

In one example, a small sized clock buffer chip (e.g., clock buffer 311) is on the M.2 UFS card 303 for driving the UFS reference clock (CLK). As mentioned above, in one example, a reserved pin of M.2 connector can be used as the UFS reference clock pin to avoid an extra multiplexer on the main board. Another reserved pin can be used as the M.2 UFS card detection signal to notify the high-speed MUX (e.g., the multiplexer 414 of FIG. 4) and the SoC on the main board to swap signals.

FIG. 9 illustrates an example of a firmware configuration to support both UFS and PCIe SSD Storage. In one example, a soft strap is configured to enable both M.2 UFS storage and PCIe SSD storage in the SoC. In the example shown in FIG. 8, to support both an M.2 UFS card and a PCIe SSD, a PCIe controller (e.g., PCIe Controller 1 in the example of FIG. 8) is configured as a ×4 PCIe and ModPhy lane 8 and lane 9 are configured as a UFS ×2. Through the UFS_DETECT input, the BIOS (e.g., a set of BIOS and Integrated firmware image (IFWI)) automatically detects the attachment of an M.2 UFS card or PCIe SSD and updates the related storage configuration. In one such example, using soft straps and the GPIO input to configure whether data lanes are PCIe or UFS can enable OEMs to use one set of PCBA (PCB assembly) board hardware and BIOS software covering different storage SKUs.

Thus, examples of an M.2 UFS card and system are described. Although specific examples include the use of multiplexer circuitry or repurposing reserved M.2 connector pins, other examples are possible. For example, various designs may include multiplexer circuitry for one or more of the data lanes, reference clock, and UFS detect signals. In other examples, pins of the M.2 connector can be repurposed or additional pins added. Furthermore, in one example of a system with multiple M.2 connectors, one M.2 connector can be designed to support an M.2 UFS card without a multiplexer (e.g., by coupling only the UFS controller with an M.2 connector and coupling the PCIe controller to a different M.2 controller).

An M.2 UFS card and system can enable improved design flexibility, cost reduction, and fast time to market. Using the same M.2 connector for an M.2 UFS card and PCIe SSD accommodates varying capacities of M.2 UFS cards, which is a challenge in traditional UFS chip-on-board designs. Furthermore, the M.2 UFS card can function as a plug-and-play device, unlike the conventional UFS chips on-board. The M.2 UFS card enables direct switching of UFS vendors, and thus enables reducing the costs of upgrading the UFS storage. The M.2 UFS card also allows customers to reduce the size of their PCBs and enhances debug efficiency.

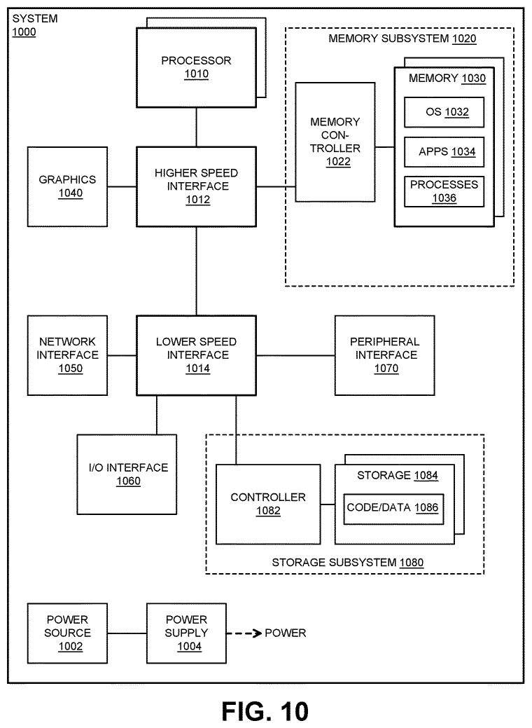

FIG. 10 is a block diagram of an embodiment of a computing system in which an M.2 UFS add in card can be included. System 1000 represents a computing device in accordance with any embodiment described herein, and can be a laptop computer, a desktop computer, a tablet computer, a server, a gaming or entertainment control system, a scanner, copier, printer, routing or switching device, embedded computing device, a smartphone, a wearable device, an internet-of-things device, or other electronic device.

System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one embodiment, system 1000 includes interface 1012 coupled to processor 1010, which can represent a higher speed interface or a high throughput interface for system components that needs higher bandwidth connections, such as memory subsystem 1020 or graphics interface components 1040. Interface 1012 represents an interface circuit, which can be a standalone component or integrated onto a processor die. Where present, graphics interface 1040 interfaces to graphics components for providing a visual display to a user of system 1000. In one embodiment, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one embodiment, the display can include a touchscreen display. In one embodiment, graphics interface 1040 generates a display based on data stored in memory 1030 or based on operations executed by processor 1010 or both. In one embodiment, graphics interface 1040 generates a display based on data stored in memory 1030 or based on operations executed by processor 1010 or both.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random-access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one embodiment, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus.

In one embodiment, system 1000 includes interface 1014, which can be coupled to interface 1012. Interface 1014 can be a lower speed interface than interface 1012. In one embodiment, interface 1014 represents an interface circuit, which can include standalone components and integrated circuitry. In one embodiment, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can exchange data with a remote device, which can include sending data stored in memory or receiving data to be stored in memory.

In one embodiment, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one embodiment, system 1000 includes storage subsystem 1080 to store data in a nonvolatile manner. In one embodiment, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one embodiment, storage subsystem 1080 includes controller 1082 to interface with storage 1084. In one embodiment controller 1082 is a physical part of interface 1014 or processor 1010 or can include circuits or logic in both processor 1010 and interface 1014.

Power source 1002 provides power to the components of system 1000. More specifically, power source 1002 typically interfaces to one or multiple power supplies 1004 in system 1000 to provide power to the components of system 1000. In one embodiment, power supply 1004 includes an AC to DC (alternating current to direct current) adapter to plug into a wall outlet. Such AC power can be renewable energy (e.g., solar power) power source 1002. In one embodiment, power source 1002 includes a DC power source, such as an external AC to DC converter. In one embodiment, power source 1002 or power supply 1004 includes wireless charging hardware to charge via proximity to a charging field. In one embodiment, power source 1002 can include an internal battery or fuel cell source.

In one example, the storage 1084 is provided with an M.2 UFS card, such as described with respect to examples herein.

Examples of M.2 cards with universal flash storage (UFS) follow.

Example 1: An apparatus including: a printed circuit board (PCB), an M.2 connector including a socket to receive an M.2 card, and universal flash storage (UFS) signal lines in or on the PCB and coupled with the M.2 connector.

Example 2: The apparatus of example 1, wherein: the UFS signal lines include UFS data lanes coupled with the M.2 connector, and wherein the apparatus further includes: PCIe data lanes coupled with the M.2 connector, and multiplexer circuitry to select the PCIe data lanes or the UFS data lanes based on an input.

Example 3: The apparatus of examples 1 or 2, wherein: the multiplexer circuitry is to select the PCIe data lanes or the UFS data lanes based on a UFS detect signal.

Example 4: The apparatus of any of examples 1-3, further including: an M.2 card including a UFS storage device.

Example 5: The apparatus of any of example 4, wherein: the M.2 card includes a clock buffer to receive a UFS clock signal via one of a plurality of pins of the M.2 connector and drive the UFS clock signal to the UFS storage device.

Example 6: The apparatus of examples 4 or 5, wherein: the M.2 card includes one or more voltage regulators to receive a voltage via the M.2 connector and provide one or more reference voltages to the UFS storage device.

Example 7: The apparatus of any of examples 1-6, wherein: one or more of the UFS signal lines are coupled with reserved pins of the M.2 connector.

Example 8: A system including: a printed circuit board (PCB) including an M.2 connector, the M.2 connector including a socket to receive an M.2 card, a universal flash storage (UFS) controller, an M.2 UFS card including a UFS storage device coupled with the M.2 connector, and UFS signal lines in or on the PCB between the SoC and the M.2 connector.

Example 9: The system of example 8, wherein: the UFS signal lines include UFS data lanes coupled with the M.2 connector, and wherein the system further includes: a PCIe controller, PCIe data lanes coupled with the M.2 connector, and multiplexer circuitry to select the PCIe data lanes or the UFS data lanes based on an input.

Example 10: The system of example 9, wherein: the multiplexer circuitry is to select the PCIe data lanes or the UFS data lanes based on a UFS detect signal.

Example 11: The system of any of examples 8-10, wherein: the M.2 UFS card includes a clock buffer to receive a UFS clock signal via one of a plurality of pins of the M.2 connector and drive the UFS clock signal to the UFS storage device.

Example 12: The system of any of examples 8-10, wherein: the M.2 UFS card includes one or more voltage regulators to receive a voltage via the M.2 connector and provide one or more reference voltages to the UFS storage device.

Example 13: The system of any of examples 8-12, wherein: one or more of the UFS signal lines are coupled with reserved pins of the M.2 connector.

Example 14: The system of any of examples 8-13, further including: a system on a chip (SoC), the SoC including one or both of the UFS controller and the PCIe controller.

Example 15: The system of any of examples 8-14, further including: one or more of: a display, a battery, and a network interface.

Example 16: An M.2 universal flash storage (UFS) card including: a printed circuit board (PCB), an edge to be received by an M.2 connector, conductive contacts at the edge to couple with contacts of the M.2 connector, a UFS storage device, and UFS signal lines between the conductive contacts and the UFS storage device.

Example 17: The M.2 UFS card of example 16, further including: a clock buffer to receive a UFS clock signal via one of a plurality of pins of the M.2 connector and drive the UFS clock signal to the UFS storage device.

Example 18: The M.2 UFS card of examples 16 or 17, further including: one or more voltage regulators to receive an M.2 supply voltage via the M.2 connector and provide one or more UFS reference voltages to the UFS storage device.

Example 19: The M.2 UFS card of any of examples 16-18, wherein: the one or more voltage regulators include one or more low drop-out regulators to receive the M.2 supply voltage and provide multiple UFS reference voltages to the UFS storage device.

Example 20: The M.2 UFS card of any of examples 16-19, wherein: the contacts of the M.2 connector include M.2 PCIe pins.

Example 21: An M.2 storage card including: a printed circuit board (PCB), an edge to be received by an M.2 connector, conductive contacts at the edge to couple with contacts of the M.2 connector, a UFS storage device, a PCIe storage device, and signal lines between the conductive contacts and the UFS storage device, and between the conductive contacts and the PCIe storage device.

Example 22: The M.2 storage card of example 21, wherein: the contacts of the M.2 connector coupled with the UFS storage device include M.2 PCIe pins for one or more PCIe lanes, and the contacts of the M.2 connector coupled with the PCIe storage device include second M.2 PCIe pins for one or more other PCIe lanes.

Example 23: The apparatus of examples 21 or 22, wherein: the PCIe data lanes coupled with the M.2 connector include multiple data lanes, wherein a subset of the multiple data lanes are inputs to the multiplexer circuitry, and wherein other PCIe data lanes bypass the multiplexer circuitry.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

The hardware design embodiments discussed above may be embodied within a semiconductor chip and/or as a description of a circuit design for eventual targeting toward a semiconductor manufacturing process. In the case of the later, such circuit descriptions may take of the form of a (e.g., VHDL or Verilog) register transfer level (RTL) circuit description, a gate level circuit description, a transistor level circuit description or mask description or various combinations thereof. Circuit descriptions are typically embodied on a computer readable storage medium (such as a CD-ROM or other type of storage technology).

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. An apparatus comprising:
a printed circuit board (PCB);
an M.2 connector including a socket to receive an M.2 card; and
universal flash storage (UFS) signal lines in or on the PCB and coupled with the M.2 connector.

2. The apparatus of claim 1, wherein:
the UFS signal lines include UFS data lanes coupled with the M.2 connector; and
wherein the apparatus further includes:
PCIe data lanes coupled with the M.2 connector, and
multiplexer circuitry to select the PCIe data lanes or the UFS data lanes based on an input.

3. The apparatus of claim 2, wherein:
the multiplexer circuitry is to select the PCIe data lanes or the UFS data lanes based on a UFS detect signal.

4. The apparatus of claim 1, further comprising:
an M.2 card including a UFS storage device.

5. The apparatus of claim 4, wherein:
the M.2 card includes a clock buffer to receive a UFS clock signal via one of a plurality of pins of the M.2 connector and drive the UFS clock signal to the UFS storage device.

6. The apparatus of claim 4, wherein:
the M.2 card includes one or more voltage regulators to receive a voltage via the M.2 connector and provide one or more reference voltages to the UFS storage device.

7. The apparatus of claim 1, wherein:
one or more of the UFS signal lines are coupled with reserved pins of the M.2 connector.

8. A system comprising:
a printed circuit board (PCB) including an M.2 connector, the M.2 connector including a socket to receive an M.2 card;
a universal flash storage (UFS) controller;
an M.2 UFS card including a UFS storage device coupled with the M.2 connector; and
UFS signal lines in or on the PCB between the SoC and the M.2 connector.

9. The system of claim 8, wherein:
the UFS signal lines include UFS data lanes coupled with the M.2 connector; and
wherein the system further includes:
a PCIe controller,
PCIe data lanes coupled with the M.2 connector, and
multiplexer circuitry to select the PCIe data lanes or the UFS data lanes based on an input.

10. The system of claim 9, wherein:
the multiplexer circuitry is to select the PCIe data lanes or the UFS data lanes based on a UFS detect signal.

11. The system of claim 8, wherein:
the M.2 UFS card includes a clock buffer to receive a UFS clock signal via one of a plurality of pins of the M.2 connector and drive the UFS clock signal to the UFS storage device.

12. The system of claim 8, wherein:
the M.2 UFS card includes one or more voltage regulators to receive a voltage via the M.2 connector and provide one or more reference voltages to the UFS storage device.

13. The system of claim 8, wherein:
one or more of the UFS signal lines are coupled with reserved pins of the M.2 connector.

14. The system of claim 8, further comprising:
a system on a chip (SoC), the SoC including one or both of the UFS controller and the PCIe controller.

15. The system of claim 8, further comprising:
one or more of: a display, a battery, and a network interface.

16. An M.2 universal flash storage (UFS) card comprising:
a printed circuit board (PCB);
an edge to be received by an M.2 connector;
conductive contacts at the edge to couple with contacts of the M.2 connector;
a UFS storage device; and
UFS signal lines between the conductive contacts and the UFS storage device.

17. The M.2 UFS card of claim 16, further comprising:
a clock buffer to receive a UFS clock signal via one of a plurality of pins of the M.2 connector and drive the UFS clock signal to the UFS storage device.

18. The M.2 UFS card of claim 16, further comprising:
one or more voltage regulators to receive an M.2 supply voltage via the M.2 connector and provide one or more UFS reference voltages to the UFS storage device.

19. The M.2 UFS card of claim 18, wherein:
the one or more voltage regulators include one or more low drop-out regulators to receive the M.2 supply voltage and provide multiple UFS reference voltages to the UFS storage device.

20. The M.2 UFS card of claim 16, wherein:
the contacts of the M.2 connector include M.2 PCIe pins.
